(19) United States
(12) Patent Application Publication
(10) Pub. No.: US 2011/0001664 A1
(43) Pub. Date: Jan. 6, 2011

(54) USE OF PHASOR MEASUREMENT UNITS FOR DIFFERENTIAL GLOBAL NAVIGATION SATELLITE SYSTEMS (DGNSS)

(75) Inventor: Dieter Olpp, München (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munich (DE)

(21) Appl. No.: 12/735,971

(22) PCT Filed: Feb. 18, 2009
(86) PCT No.: PCT/EP2009/051928

§ 371 Date: Aug. 27, 2010

(30) Foreign Application Priority Data
Feb. 29, 2008 (DE) 10 2008 011 824.9

(51) Int. Cl. G01S 19/41

(52) U.S. Cl. 342/357.24

(57) ABSTRACT

A system determines and transmits correctional data of a global navigation satellite system (GNSS) which has a plurality of reference stations that can be used to determine the correction data by repeatedly measuring the position of the reference stations and comparing it to the previously determined exact position. The data determined in this manner are transmitted to a central station via a network and optionally processed in the central station. Such a system requires that every reference station be equipped with a GNSS receiver, but it is especially the connection to the central station that requires considerable financial resources for the establishment of the connection and both for the maintenance and operation of the network. An already existing network of the phasor measurement units of a power transmission network is therefore used.

### CROSS REFERENCE TO RELATED APPLICATIONS

This application is the U.S. national stage of International Application No. PCT/EP2009/051928, filed Feb. 18, 2009 and claims the benefit thereof. The International Application claims the benefits of German Application No. 102008011824.9 filed on Feb. 29, 2008, both applications are incorporated by reference herein in their entirety.

### BACKGROUND

Described below is a method for the determination and transmission of correction data of a global navigation satellite system.

Global navigation satellite systems (GNSS) such as GPS, for example, have been known for a long time. In order to increase the accuracy of the position determination, differential GNSS systems have been introduced as an enhancement of the hitherto customary GNSS in which a multiplicity of reference stations are used whose geographical positions were determined exactly for example at the time of the installation of the reference stations, for example by one-time, high-precision geodetic measurements.

Each reference station is equipped with a GNSS receiver, i.e. with a receiver for the GNSS, with the aid of which receiver the reference station determines its currently measured position at regular intervals via the GNSS. The measured position can, however, deviate from the exact position due to error factors acting as a function of distance, such as, for example, the strength of ionospheric activity, inadequately modeled satellite orbits and/or propagation delays of the signal in the troposphere. Accordingly a position determination of a user of the GNSS would also be incorrect.

As is known from DE 198 36 966 A1, for example, correction data for the GNSS can be computed from the comparison of the known, exact position of the reference station with the measured position of the reference station and the inaccurate position determination can be corrected with the aid of the data. In the simplest case the correction data can be subtracted from the measured positions of the user, for example.

In the vicinity of the reference station for which the correction data was determined, the correction data can be used by a user who wants to determine his/her position by a GNSS receiver since it is to be assumed that in the immediate environment of the reference station substantially the same measurement error has an effect or, as the case may be, the same error factors come into play. The user's GNSS receiver is accordingly subject to the same error as the receiver of the reference station. The correction data is therefore transferred for example via radio, cellular mobile telephony and/or internet to the users of the GNSS so that the users can likewise correct their measured position.

Error factors acting as a function of distance can be significantly reduced by a common evaluation of data from a network of reference stations. Networking the reference stations brings with it the advantage that spatial changes in the error factors can be estimated substantially better from observations of reference stations that are distributed over a wide area and coordinated in a highly precise manner than if individual reference stations are considered. The correction data and/or the currently measured positions of the reference station are therefore transferred by the reference stations via a corresponding network to a control center where the data and/or positions are collected and analyzed further. The correction data aggregated in the control center is finally made available to the users of the GNSS for example via radio, cellular mobile telephony and/or internet.

A dense network of reference stations is a prerequisite for a differential GNSS. In this case each reference station must include a GNSS receiver and be connected to the control center by a communication line. Networks of reference stations of the type are the SAPOS and ASCOS systems for example.

In addition to the requirement that each reference station must be equipped with a GNSS receiver, the connection to the control center in particular necessitates a considerable financial outlay both for the setting up of the connection and for the operation and maintenance of the network.

### SUMMARY

An aspect is therefore an affordable system by which correction data of a differential GNSS can be determined and transmitted to a control center.

In the system use is made of the knowledge that phasor measuring devices, referred to as “Phasor Measurement Units” (PMUs), have been deployed increasingly in existing electric power transmission networks over the last several years. A system of this type is described in U.S. Pat. No. 7,200,500 B2, for example. A PMU is able to measure the current voltage and the phase angle at a specific position of the network with very precise time synchronization in order to make the phase angles of points lying at a great distance from one another in the network comparable. For this purpose each of the PMUs is equipped with a GNSS receiver since the position determination is accomplished by way of the comparison of signal propagation times to different satellite and therefore presupposes a precise time synchronization.

The data measured by the PMUs is merged in a control center for the purpose of network-wide monitoring (wide area monitoring). The PMUs are therefore interconnected via communication links to form a PMU network and are connected to the control center. The phasor data and corresponding timestamps are transferred to the control center via the communication links.

The system uses the existing PMU network as a network of reference stations while utilizing the GNSS receivers integrated in the PMUs for a differential GNSS or as an extension of such a network. Only a small additional overhead is necessary for this:
The precise geographical positions of the GNSS receivers of the PMUs are determined one time only by geodetic measurements, for example.
During ongoing operation the positions determined via the GNSS and/or the correction data derived therefrom are transferred via the communication links to the control center of the PMU network in addition to the phasor data and the timestamps of the PMUs.
In the control center the incoming correction data or the correction data computed in the control center from the position data is aggregated and made available to the GNSS users. Since the control center originally operates solely as a control center of the electric power transmission network and therefore no provision is made for the function of computing and/or further processing the GNSS correction data, the correction or position data arriving from the PMUs can alternatively be forwarded by the control center to a special GNSS control center where the further data processing then takes place.

The advantage of the system lies in the fact that a facility that is present anyway, namely the network of PMUs having GNSS receivers and communication links, can be used for a purpose other than the original one, namely in addition also for implementing a network of reference stations for a differential GNSS. This saves a major part of the above-described expenditure required for setting up and operating a separate network consisting of GNSS reference stations.

Because of the enormous size of electric power transmission networks a correspondingly large number of reference stations and consequently a very precise position determination can be implemented via the differential GNSS.

The transmission of phasor data is regulated by the IEEE C37.118 standard, which among other things defines a data format for the measured values. The data format could if necessary be extended by an additional field for the position determined via the GNSS.

Alternatively to the above-described use of the communication links of the electric power transmission network it is also possible to have recourse to the communication links of a different communication network, for example a mobile communications network or a fixed line network.

### BRIEF DESCRIPTION OF THE DRAWINGS

These and other aspects and advantages will become more apparent and more readily appreciated from the following description of the exemplary embodiment, taken in conjunction with the accompanying drawing which:

FIG. 1 shows an electric power transmission network having phasor measurement units for use as reference stations of a differential GNSS.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

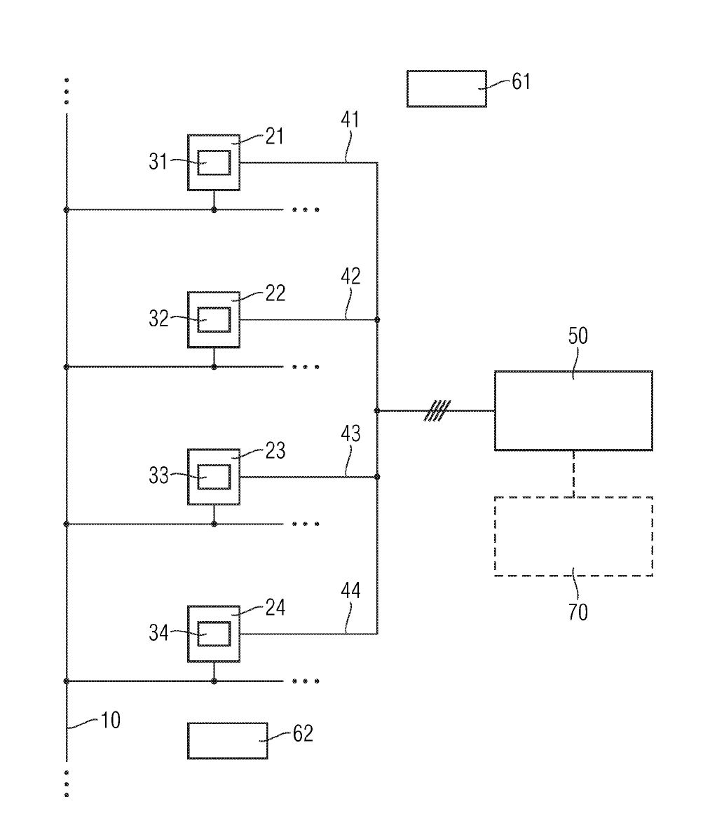

FIG. 1 shows in a schematic representation an electric power transmission network 10 having a plurality of phasor measurement units 21-24 (PMUs), four in the example, each of which includes a GNSS receiver 31-34. The PMUs 21-24 are connected via communication links 41-44 to a control center 50 of the electric power transmission network, to which they transfer the phasor data and the timestamps. As well as performing their intrinsic function as voltage and phase angle measuring stations, the PMUs 21-24 additionally fulfill the function of reference stations of a differential GNSS network.

At a specific point in time, for example within the framework of the installation of the PMUs 21-24, an exact determination of the positions of the PMUs 21-24 is performed one time only, for example by a geodetic measurement. During operation the positions of the individual PMUs 21-24 are repeatedly measured via the GNSS in a manner known per se with the aid of the GNSS receivers 31-34. The measured positions are then compared with the previously determined exact positions, in particular a difference between the measured position and the exact position being formed in the process. As described above, the possibility cannot be ruled out that the measured position of one (or more) of the PMUs 21-24, for example PMU 21, is different from the exact position. This indicates that the GNSS is not operating correctly, in other words, therefore, that positions of users 61, 62 of the GNSS are not necessarily determined correctly.

For each of the PMUs 21-24 the comparison results in correction data that is used in order to compensate for the measurement error in the form of the deviation of the measured position from the exact position. In this case the comparison can take place either in each of the PMUs 21-24 separately or in the control center 70 only after the measured positions have been transmitted. In the former case the respective exact position is stored in each of the PMUs 21-24 and the correction data is computed directly in the respective PMU 21-24 in each case. The thus computed correction data is transmitted to the control center 50 via the communication links 41-44. In the latter case the respective measured position of the PMUs 21-24 is transferred directly to the control center 50 via the communication links 41-44. The exact positions of the PMUs 21-24 are stored in the control center 50, and the comparison and determination of the correction data take place in the control center 50.

The correction data is collected in the control center 50 and transferred to the users 61, 62 of the GNSS via, for example, radio, cellular mobile telephony or internet, where it is taken into account by the respective GNSS receiver (not shown specifically) during the position determination.

In general it is to be assumed that the control center 50 is only the control center of the electric power transmission network. The control center 50 of the electric power transmission network is then for its part connected to a (GNSS) control center 70 to which the correction data determined in the reference stations or, as the case may be, the measured positions are transmitted. The remaining above-described functions of the control center 50 are then handled by the control center 70.

The communication links 41-44 may be the communication links of the electric power transmission network. Alternatively, however, communication links of a different communication network such as e.g. a mobile communications network or fixed line network can be used. In this case the data collected by the PMUs and to be transmitted to the control center 50, 70, i.e. measured positions and/or the correction data, would be fed into the communication network and there transferred to the control center using the existing network connections.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-7. (canceled)

8. A method for determining and transmitting correction data for a global navigation satellite system having at least one reference station, comprising:
repeatedly obtaining, by the global navigation satellite system, a measured position of a phasor measurement unit of an electric power transmission network, as a reference station;
comparing, in the phasor measurement unit, the measured position with an exact position of the phasor measurement unit to determine the correction data; and
transmitting the correction data from the phasor measurement unit to a control center via communication links of the electric power transmission network or via communication links of a mobile communications or fixed line network.

9. The method as claimed in claim 8, wherein the correction data is a difference between the exact position and the measured position of the phasor measurement unit.

10. The method as claimed in claim 9, wherein the correction data is collected in the control center.

11. The method as claimed in claim 10, wherein the correction data is transferred from the control center via radio, cellular mobile telephony or Internet to users of the global navigation satellite system.

12. The method as claimed in claim 11, wherein the exact position of the phasor measurement unit is determined one time only prior to use of the phasor measurement unit as the reference station.

13. A method for determining correction data for a global navigation satellite system having at least one reference station, comprising:
repeatedly obtaining, by the global navigation satellite system, a measured position of a phasor measurement unit of an electric power transmission network, as a reference station;
transmitting the measured position to a control center via communication links of the electric power transmission network or via communication links of a mobile communications or fixed line network; and
comparing, in the control center, the measured position with an exact position of the phasor measurement unit to determine the correction data.

14. The method as claimed in claim 13, wherein the correction data is the difference between the exact position and the measured position of the phasor measurement unit.

15. The method as claimed in claim 14, wherein the correction data is collected in the control center.

16. The method as claimed in claim 15, wherein the correction data is transferred from the control center via radio, cellular mobile telephony or Internet to users of the global navigation satellite system.

17. The method as claimed in claim 16, wherein the exact position of the phasor measurement unit is determined one time only prior to use of the phasor measurement unit as the reference station.

18. A system for determining and transmitting correction data of a global navigation satellite system having at least one reference station which is connected to a control center via communication links, comprising:
at least one phasor measurement unit of an electric power transmission network, serving as the reference station, including
a global navigation satellite system receiver obtaining a measured position; and
a transmitter transmitting at least one of the measured position and correction data for the global navigation satellite system to the control center via the communication links provided by the electric power transmission network or a mobile communications or fixed line network.
